(19) United States
(12) Patent Application Publication
(10) Pub. No.: US 2026/0126296 A1
(43) Pub. Date: May 7, 2026

(54) LARGE-SCALE DISPATCHING UTILIZING LARGE NEIGHBORHOOD SEARCH

(71) Applicant: International Business Machines Corporation, Armonk, NY (US)

(72) Inventors: Dung Tien Phan, Yorktown Heights, NY (US); Ali Koc, White Plains, NY (US); Francisco Barahona, YORKTOWN HEIGHTS, NY (US)

(21) Appl. No.: 18/935,828

(22) Filed: Nov. 4, 2024

(51) Int. Cl. G01C 21/34; G08G 1/00

(52) U.S. Cl. CPC G01C 21/3415; G08G 1/202

(57) ABSTRACT

An example operation may include one or more of receiving a geographic map that comprises tasks assigned to a plurality of vehicles, and routes for the plurality of vehicles to follow to perform the tasks, clustering the routes into a plurality of subsets of routes based on travel times from geographic locations of the routes in the geographic map, wherein each subset of routes corresponds to a different geographic location, executing a large neighborhood search (LNS) on the plurality of subsets of routes to generate a plurality of modified subsets of routes for the plurality of vehicles to follow to perform the tasks, updating the geographic map based on the plurality of modified subsets of routes, and dispatching the tasks to the plurality of vehicles via a communication channel based on the updated geographic map.

### BACKGROUND

Scheduling software, such as workforce management software, can schedule tasks. For example, the software may determine an optimal set of routes for a group of vehicles and associated crews to serve a given set of customers, each with specific demands, while minimizing the total cost. The software often considers various constraints such as different time windows, multiple depots with heterogeneous vehicles, multiple commodities, synchronized shifts, crew availability, and the like. Current scheduling software can take a long time to properly provide a set of routes for the group of vehicles/crews when the problem involves a large number of tasks.

### SUMMARY

One example embodiment provides a computer system for optimizing scheduling and dispatching of tasks, the computer system includes a memory, and at least one processor communicatively coupled to the memory, and the at least one processor configured to at least one of receive a geographic map that comprises tasks assigned to a plurality of vehicles, and routes for the plurality of vehicles to follow to perform the tasks, cluster the routes into a plurality of subsets of routes based on travel times from geographic locations of the routes in the geographic map, wherein each subset of routes corresponds to a different geographic location, execute a large neighborhood search (LNS) on the plurality of subsets of routes to generate a plurality of modified subsets of routes for the plurality of vehicles to follow to perform the tasks, update the geographic map based on the plurality of modified subsets of routes, and dispatch the tasks to the plurality of vehicles via a communication channel based on the updated geographic map.

Another example embodiment provides a computer-implemented method for optimizing scheduling and dispatching of tasks, the computer-implemented method including at least one of receiving a geographic map that comprises tasks assigned to a plurality of vehicles, and routes for the plurality of vehicles to follow to perform the tasks, clustering the routes into a plurality of subsets of routes based on travel times from geographic locations of the routes in the geographic map, wherein each subset of routes corresponds to a different geographic location, executing a large neighborhood search (LNS) on the plurality of subsets of routes to generate a plurality of modified subsets of routes for the plurality of vehicles to follow to perform the tasks, updating the geographic map based on the plurality of modified subsets of routes, and dispatching the tasks to the plurality of vehicles via a communication channel based on the updated geographic map.

A further example embodiment provides a computer program product for optimizing scheduling and dispatching of tasks, the computer program product includes a computer-readable storage medium and program instructions stored on the computer-readable storage medium, wherein the program instructions are executable by a computer processor causing the computer processor to perform one or more functions, the program instructions include at least one of program instructions to receive a geographic map that comprises tasks assigned to a plurality of vehicles, and routes for the plurality of vehicles to follow to perform the tasks, program instructions to cluster the routes into a plurality of subsets of routes based on travel times from geographic locations of the routes in the geographic map, wherein each subset of routes corresponds to a different geographic location, program instructions to execute a large neighborhood search (LNS) on the plurality of subsets of routes to generate a plurality of modified subsets of routes for the plurality of vehicles to follow to perform the tasks, program instructions to update the geographic map based on the plurality of modified subsets of routes, and program instructions to dispatch the tasks to the plurality of vehicles via a communication channel based on the updated geographic map.

### BRIEF DESCRIPTION OF THE DRAWINGS

FIG. 1 is a diagram illustrating a computing environment according to an embodiment of the instant solution.

FIG. 2A is a diagram illustrating a process of generating modified dispatch instructions for a set of tasks according to the examples and features of the instant solution.

FIG. 2B is a diagram illustrating a process of generating modified dispatch instructions using parallel processing according to the examples and features of the instant solution.

FIG. 2C is a diagram illustrating a process of dispatching the tasks to a group of vehicles (crews) based on the modified dispatch instructions according to the examples and features of the instant solution.

FIG. 3A is a diagram illustrating a geographic map showing a plurality of routes for a plurality of vehicles according to the examples and features of the instant solution.

FIG. 3B is a diagram illustrating a process of decomposing a group of tasks by clustering routes together among the plurality of routes according to the examples and features of the instant solution.

FIG. 4A is a diagram illustrating a view of tasks initially assigned to two routes according to the examples and features of the instant solution.

FIG. 4B is a diagram illustrating a process of removing a subset of tasks initially assigned to the two routes according to the examples and features of the instant solution.

FIG. 4C is a diagram illustrating a process of annealing the subset of tasks previously removed to the two routes according to the examples and features of the instant solution.

FIG. 5A is a diagram illustrating a flow diagram, according to example embodiments.

FIG. 5B is a diagram illustrating a flow diagram, according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to software, such as enterprise asset management software (e.g., field scheduling software, etc.), which can optimize schedules of tasks that are assigned to groups of vehicles/crews. The software may solve for optimal task assignments, routes, schedules, etc., for large-scale dispatching scenarios that involve many tasks and multiple vehicles/crews (e.g., one or more drivers of vehicles). The software may start with an initial solution (e.g., dispatch instructions) and optimize the dispatch instructions by modifying routes, tasks, vehicles, and the like. The software may decompose the initial solution (e.g., initial routes) into multiple smaller problems, and then execute a large neighborhood search (LNS) algorithm on each of the smaller problems to generate optimal solutions for each of the smaller problems. The software may then combine the results from the solutions to the smaller problems into a large-scale solution with optimal routing.

Traditional field scheduling software relies on constraint programming Optimizer (CPO) solvers or mixed-integer programming optimizers (MILPs) which identify feasible solutions from a large set of candidates by modeling the problem with constraints. CPO solvers and MILPs may require, for example, an average of 20 minutes to identify optimal routes and task assignments for a large-scale dispatch problem that involves 1,000 tasks and a dozen or so drivers. The system described herein can reduce the average time down to around 1 to around 2 minutes for similar scenarios (or problems) using a combination of task decomposition and solving for the optimal solution using the LNS algorithm. Furthermore, testing has shown that the system described herein can assign more optimal routes (e.g., less travel time, fewer tasks, fewer vehicles, etc.) than traditional field scheduling software. As such, the system described herein is a significant improvement to traditional field scheduling software because it significantly increases the speed of the optimization process (e.g., by almost 10 times) and provides a more accurate solution than traditional field scheduling algorithms.

Field workforce management software can be used to plan, schedule, dispatch, and track work/tasks efficiently. Field workforce management typically entails dispatching workers to an off-site location for tasks, such as equipment installation, maintenance, deliveries, asset repair, and the like, in view of operational and budget constraints. Traditional algorithms use CPO and MILP; however, these algorithms are not always accurate in handling complex scheduling tasks.

The system described herein uses a new LNS algorithm that is scalable and that can dispatch thousands of tasks and crews (e.g., technicians) along more optimal routes and in significantly less time in comparison to CPO and MILP algorithms. The software can decompose the problem into multiple smaller problems and execute the LNS algorithm on each of the smaller problems in parallel using multi-threading parallelization which does not require clusters or GPUs, saving significant overhead. The instant LNS solution may be a stochastic large neighborhood search, based on simulated annealing, scoring, and destruction and construction. Furthermore, in the instant solution, various LNS techniques can be used to handle different business objectives such as travel distance, unperformed tasks, assignment criteria, prioritization, etc. as well as multiple business rules.

The scheduling software that is described herein may be implemented within a software application, service, or the like, which may be hosted by a host platform such as a cloud platform, a web server, a database, a distributed system, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

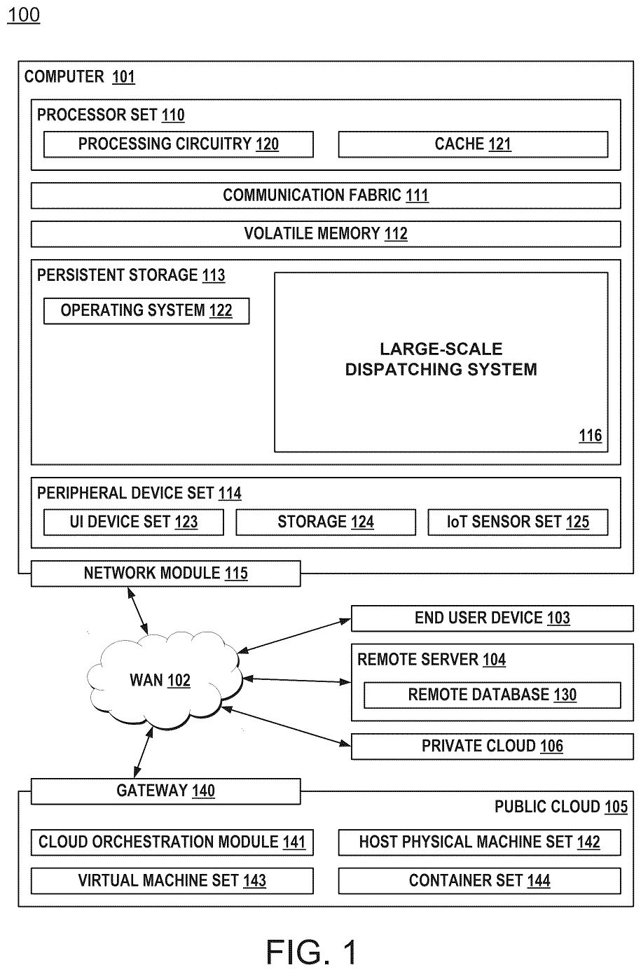

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as large-scale dispatching system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

The instant example embodiments are directed to a software application, such as a field service management software application that is configured to schedule large-scale tasks to multiple crews, vehicles, etc. Examples of the tasks include delivery tasks, service tasks, maintenance tasks, etc. The solution uses a multi-step approach to improve the traditional scheduling process performed by traditional field service management software. In the instant example embodiments, an initial scenario (or solution) is decomposed, divided, or disassembled into multiple smaller problems that can be solved simultaneously, for example. An instance of an LNS model can be applied to each of the multiple smaller problems, (e.g., in parallel) to identify modifications to routes, tasks, etc. in the smaller problems. The instant software combines the solutions into a full-size modification of the initial solution that is optimized. The software can improve both CPU processing time, as well as the accuracy and efficiency of the routes and task assignments.

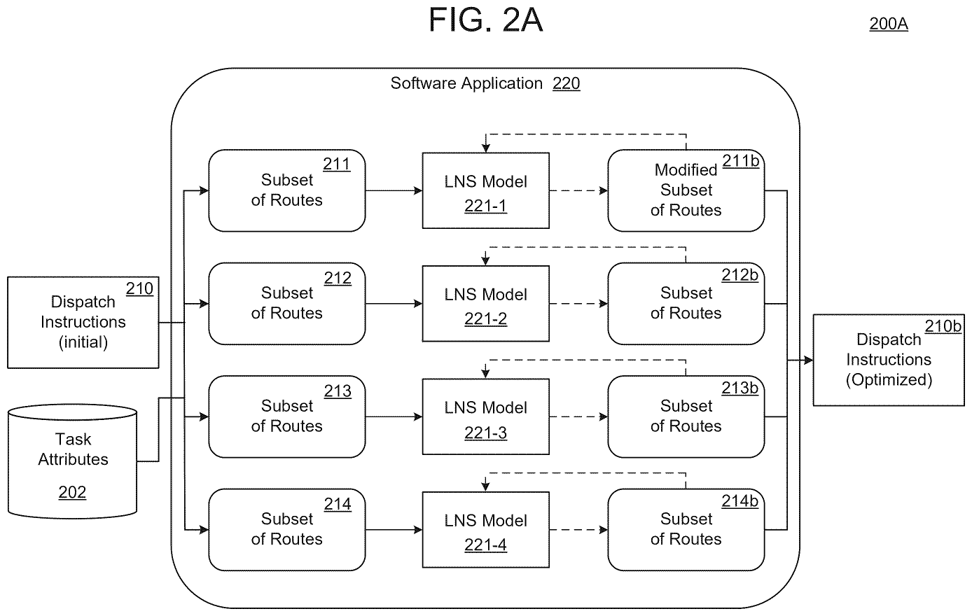

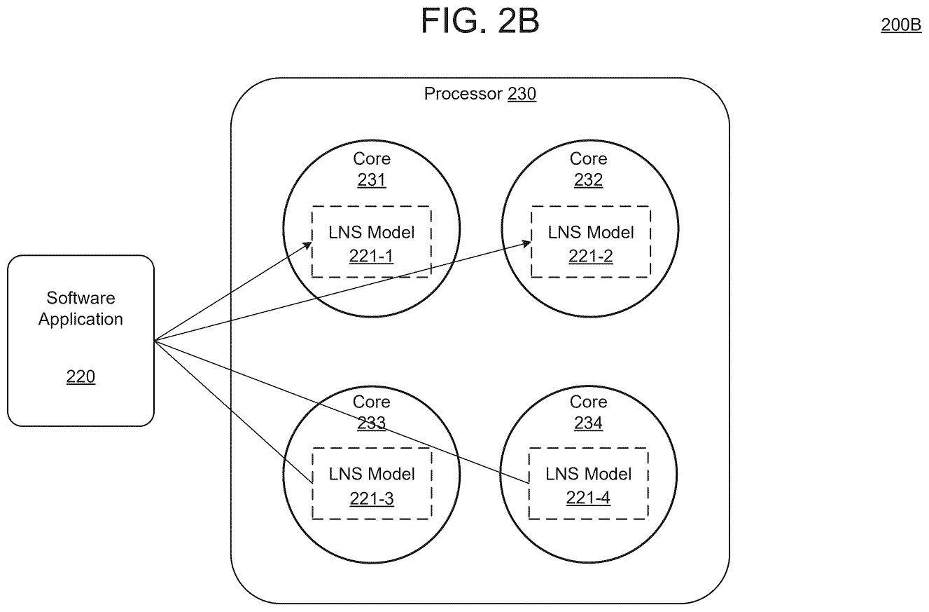

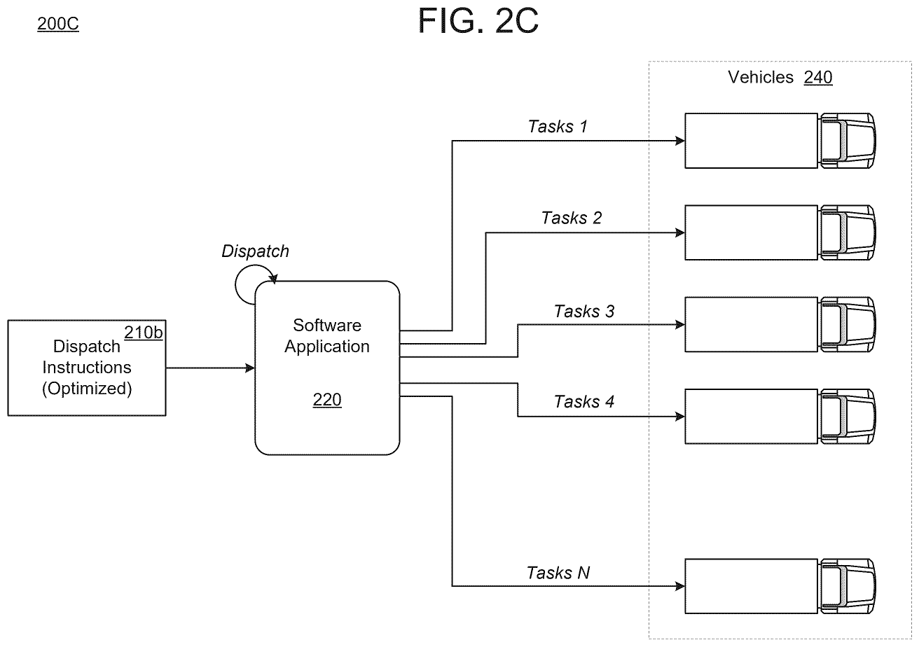

FIG. 2A illustrates a process 200A of generating modified dispatch instructions for a set of tasks according to the examples and features of the instant solution, and FIG. 2B illustrates a process 200B of generating the modified dispatch instructions using parallel processing according to the examples and features of the instant solution.

Referring to FIG. 2A, a software application 220 may optimize initial dispatch instructions 210 and convert the initial dispatch instructions into optimized dispatch instructions 210b which include different routes, different task assignments, different users, vehicles, and/or the like. Although not shown in FIG. 2A, the software application 220 may be hosted by a host platform and accessed by a user with a computing device over a computer network. As an example, the software application 220 may be a progressive web application or the like which is available on a network such as the Internet, a private network, or the like. The user may enter a URL, IP address, or the like of the software application 220 into a browser of the computing device to access the software application 220. Alternatively, the user may provide verbal instructions to access and control the software application 220.

The process shown in FIG. 2A may begin with an initial set of dispatch instructions 210, which may may be generated using traditional methods, for example, using a constraint programming optimizer (CPO) solver, a mixed-integer linear programming (MILP) algorithm, or the like. The initial set of dispatch instructions 210 may include a plurality of routes assigned to a plurality of vehicles. Each route may include a different set of tasks to be performed by the respective vehicle, crew, etc. Each route may be defined on a geographic map with geographic coordinates of the route displayed on the geographic map.

According to various embodiments, the software application 220 may divide the initial set of dispatch instructions 210 into a plurality of smaller subsets of routes 211, 212, 213, and 214, where each subset of routes includes a small portion of the total amount of routes that are included in the initial set of dispatch instructions 210. As an example, the software application 220 may cluster routes that are near each other geographically to arrive at the plurality of smaller subsets of routes 211, 212, 213, and 214. In addition, the software application 220 may also ingest task attributes 202 associated with the tasks, such as windows of time which the tasks are to be performed, as well as vehicle types, crew types, geographic locations, and the like, which are required for the tasks.

According to various embodiments, the software application 220 may launch a plurality of instances of a LNS model 221, including an instance 221-1, an instance 221-2, an instance 221-3, and an instance 221-4. Each of the instances may be executed in parallel, for example, as shown in the example of FIG. 2B. Each of the instances may be assigned to a different processing core of a multicore processor 230 and performed in parallel. In the example of FIG. 2B, the instance 221-1 is allocated to a processing core 231, the instance 221-2 is allocated to a processing core 232, the instance 221-3 is allocated to a processing core 233, and the instance 221-4 is allocated to a processing core 234. The process can be scaled to include as many cores as necessary to execute as many instances of the LNS process as needed.

Each of the instances of the LNS process may generate modified subsets of routes. For example, the instance 221-1 may be executed on the subset of routes 211 to generate a modified subset of routes 211b. In addition, the instance 221-2 may be executed on the subset of routes 212 to generate a modified subset of routes 212b, the instance 221-3 may be executed on the subset of routes 213 to generate a modified subset of routes 213b, and the instance 221-4 may be executed on the subset of routes 214 to generate a modified subset of routes 214b. The software application 220 may combine the modified subset of routes 211b, the modified subset of routes 212b, the modified subset of routes 213b, and the modified subset of routes 214b, to generate a modified set of dispatch instructions 210b.

According to various embodiments, the software application 220 may determine whether the modified dispatch instructions 210b are more efficient or otherwise improved with respect to the initial dispatch instructions 210. For example, the software application 220 may determine whether the total travel time is reduced in the modified dispatch instructions 210b in comparison to the initial dispatch instructions 210. As another example, the software application 220 may determine whether the number of stops, tasks, vehicles, etc. is reduced in the modified dispatch instructions 210b in comparison to the initial dispatch instructions 210. If the modified dispatch instructions 210b are an improvement, the modified dispatch instructions 210b may be kept, and the initial dispatch instructions 210 may be discarded. Furthermore, the modification process shown in FIG. 2A may be iteratively performed, for example, for a predetermined number of intervals (e.g., 10, 20, 50, etc.). As another example, the modification process shown in FIG. 2A may be iteratively performed until another stop condition is achieved such as a user input, a certain threshold of travel time being achieved, or the like.

FIG. 2C illustrates a process 200C of dispatching the tasks to a group of vehicles/crews based on the modified dispatch instructions 210b according to the examples and features of the instant solution. Referring to FIG. 2C, the software application 220 may identify a subset of tasks to be dispatched to each vehicle among a set of vehicles 240, and routes on which the subset of tasks are to be performed. The software application 220 may send instructions to each of the vehicles in the set of vehicles 240 with the routing instructions, task identifiers, time periods, and the like. For example, the software application 220 may display the routing instructions on a navigation system, infotainment system, etc. of the vehicles in the set of vehicles 240.

In some embodiments, the instructions that are provided from the software application 220 to the vehicles may include routing instructions for autonomous vehicles, including geographic routes on which the vehicles should travel to arrive at each of the tasks, in an order in which the tasks are assigned, etc.

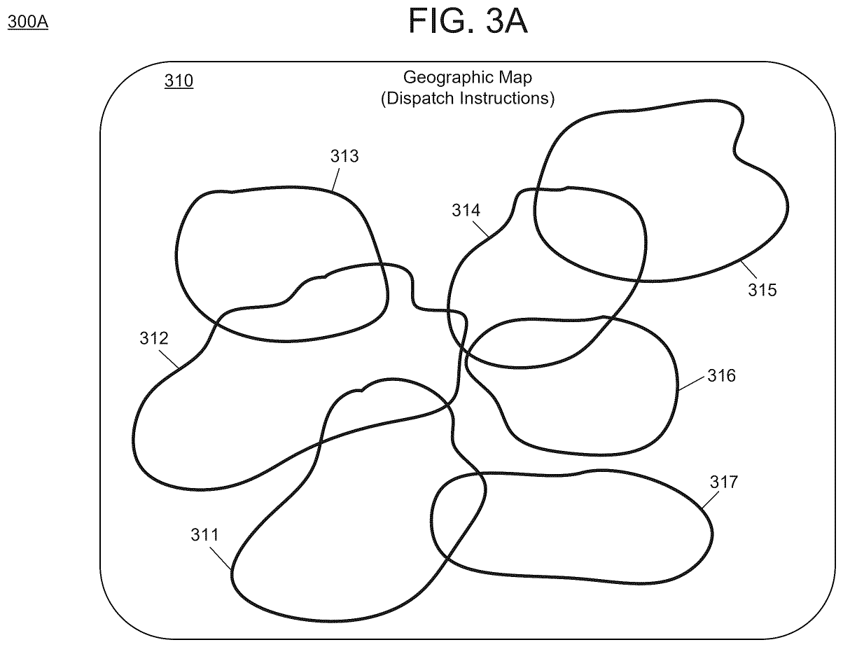

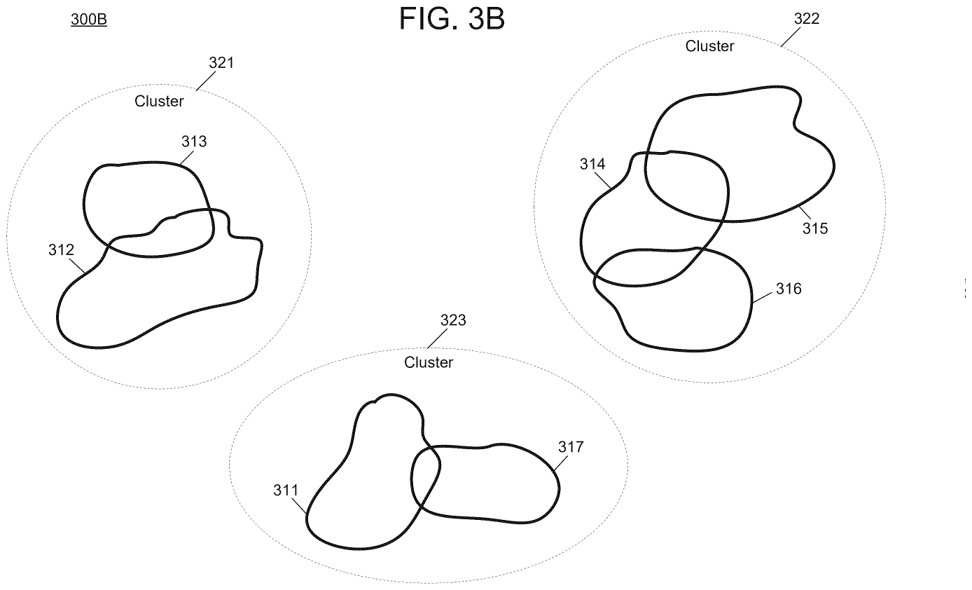

FIG. 3A illustrates a view 300A of a geographic map showing a plurality of routes for a plurality of vehicles according to the examples and features of the instant solution, and FIG. 3B illustrates a process 300B of decomposing a group of tasks by clustering routes together among the plurality of routes according to the examples and features of the instant solution. Referring to FIG. 3A, the initial dispatch instructions (e.g., the initial dispatch instructions 210 shown in the example of FIG. 2A, or the like) may include a plurality of routes assigned to a plurality of vehicles, respectively. Each route may include a different set of tasks to be performed.

In the example of FIG. 3A, there are multiple routes including route 311, route 312, route 313, route 314, route 315, route 316, and route 317 which are displayed on a geographic map 310. The geographic map 310 may be output on a graphical user interface (GUI) that can be displayed by a display device within a vehicle, or the like. Each of the routes may include driving instructions including geographic coordinates of the locations of the tasks, the roads to travel, and the like. According to various embodiments, the software application described herein may disassemble the optimization problem into a plurality of smaller problems by clustering together subsets of routes that are located near one another.

For example, in FIG. 3B, the software application generates three clusters of routes including a first cluster 321 that includes the route 312 and the route 313, a second cluster 322 that includes the route 314, the route 315, and the route 316, and a third cluster 323 that includes the route 311 and the route 317. The tasks and routes within each of the clusters may be optimized separately and in parallel by the software application. By clustering the routes (and their corresponding tasks), the software application is able to decompose the large-scale dispatch problem into multiple smaller problems reducing the complexity of the solution that needs to be generated by the optimization process. This causes a faster/speedier execution by the optimization process. The faster execution can be realized through the reduction in complexity of the dispatching process (e.g., by breaking down a set of routes into smaller subsets/clusters of routes) and through the parallel processing of the LNS algorithm on the subsets of routes.

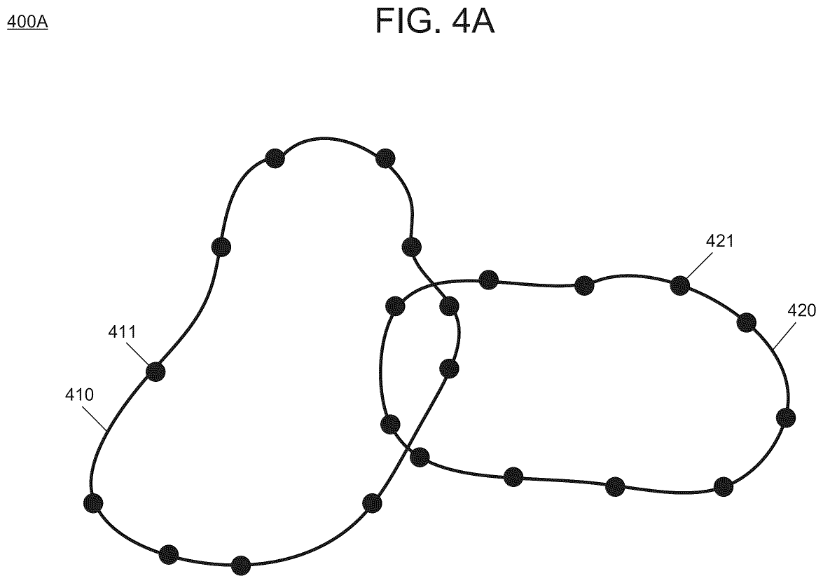

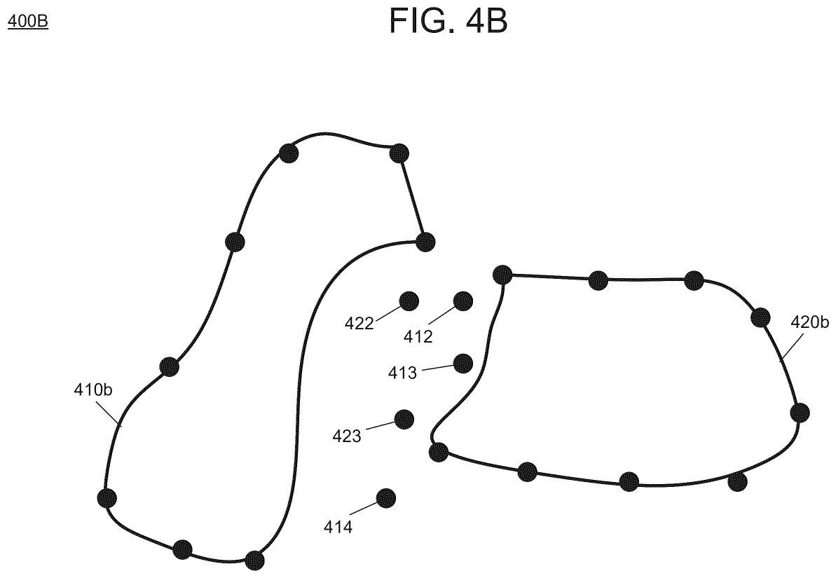

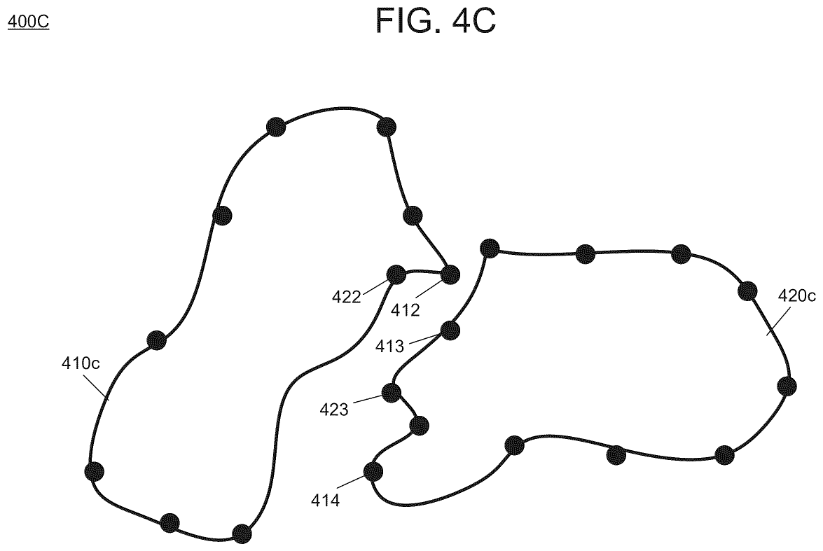

FIG. 4A illustrates a view 400A of tasks initially assigned to two routes according to the examples and features of the instant solution. Referring to FIG. 4A, two routes are shown in a cluster together including a route 410 and a route 420. For example, the route 410 and the route 420 may correspond to the route 311 and the route 317 shown in the example of FIG. 3B, however, embodiments are not limited thereto. As shown in the example of FIG. 4A, each route includes a plurality of tasks and locations along the routes where the tasks are to be performed. The tasks are represented using dark circles. For example, the route 410 includes tasks 411 and the route 420 includes tasks 421.

According to various embodiments, the LNS process that is executed by the software application herein may destroy these routes by removing tasks from the routes (e.g., randomly), modifying the routes, and then adding the removed tasks back to the routes (e.g., randomly). The process may be referred to as stochastic destroying and stochastic annealing.

FIG. 4B illustrates a process 400B of removing a subset of tasks initially assigned to the two routes according to the examples and features of the instant solution. The process 400B shown in FIG. 4B may be referred to as simulated destroying of the routes using the software. In this example, the LNS algorithm may remove one or more tasks from the route 410, for example, tasks 412, 413, and 414. Likewise, the LNS algorithm may remove one or more tasks from the route 420 such as the task 422 and the task 423. The result is a modified route 410b and a modified route 420b. The decision on which tasks to be removed may be randomly chosen by the LNS process. Furthermore, the LNS model may reconnect the routes while the missing tasks are no longer present, thereby enabling the modified routes 410b and 420b to be generated.

FIG. 4C illustrates a process 400C of annealing the subset of tasks previously removed to the two routes according to the examples and features of the instant solution. Referring to FIG. 4C, the software application may execute one or more algorithms, for example, a greedy algorithm, a regret algorithm, or the like, which decide where the missing tasks get added back to the modified routes 410b and 420b. The missing tasks may be added to either of the routes, depending on the algorithm execution results. In the example of FIG. 4C, the task 412 and the task 422 are annealed/inserted within the modified route 410b to create a further modified route 410c. Likewise, the task 413, the task 423, and the task 414 are annealed/inserted to the modified route 420b to create a further modified route 420c.

These modifications may be verified to ensure that the further modified routes 410c and 420c are more efficient than the previous routes 410 and 420. For example, travel time may be analyzed to determine if the modifications result in reduced travel time. As another example, the number of tasks, the number of vehicles, the number of people involved, etc. may be analyzed to determine if there is an improvement. The further modified routes 410c and 420c may be the end of the process, and may be used for dispatching. As another example, the process performed in FIGS. 4B and 4C may be repeated on an iterative basis to generate additional routes. The software application may use a script or other executable to iteratively execute the LNS process (e.g., the destroying, annealing, etc.).

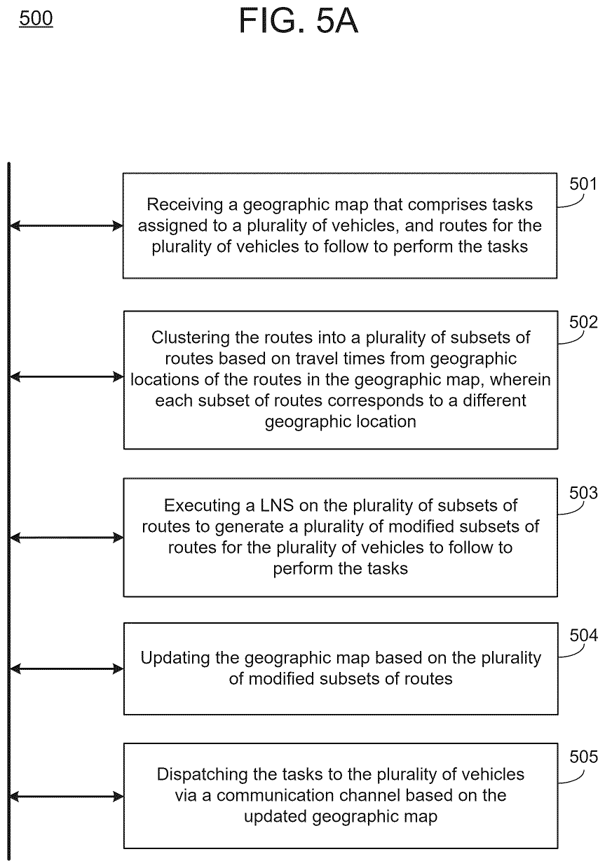

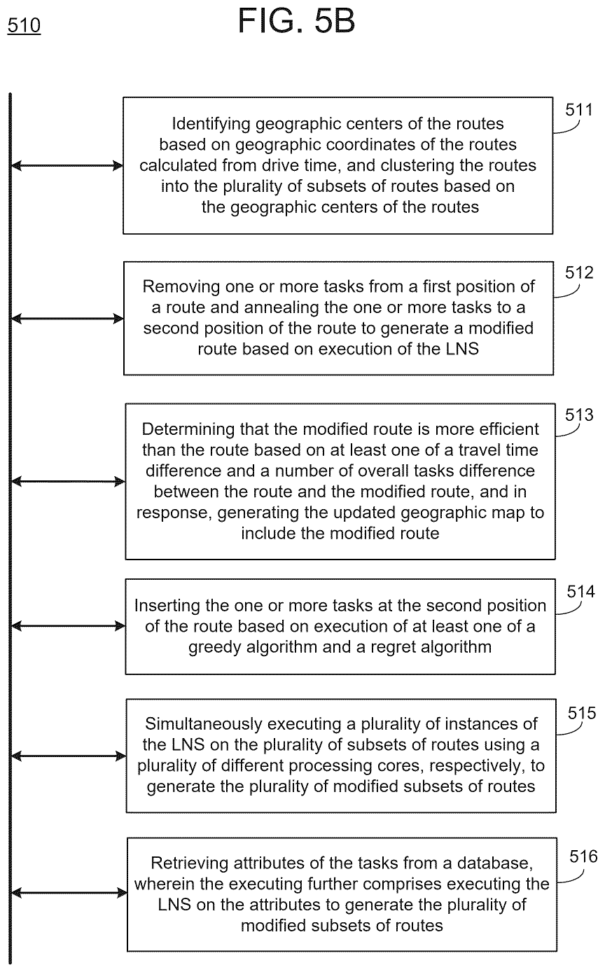

FIG. 5A illustrates a flow diagram of a method 500, according to example embodiments. Referring to FIG. 5A, in 501, the method may include receiving a geographic map that comprises tasks assigned to a plurality of vehicles, and routes for the plurality of vehicles to follow to perform the tasks. In 502, the method may include clustering the routes into a plurality of subsets of routes based on travel times from geographic locations of the routes in the geographic map, wherein each subset of routes corresponds to a different geographic location. In 503, the method may include executing a large neighborhood search (LNS) on the plurality of subsets of routes to generate a plurality of modified subsets of routes for the plurality of vehicles to follow to perform the tasks. In 504, the method may include updating the geographic map based on the plurality of modified subsets of routes. In 505, the method may include dispatching the tasks to the plurality of vehicles via a communication channel based on the updated geographic map.

FIG. 5B illustrates a flow diagram of a method 510, according to example embodiments. Referring to FIG. 5B, in 511, the method may include identifying geographic centers of the routes based on geographic coordinates of the routes calculated from drive time, and clustering the routes into the plurality of subsets of routes based on the geographic centers of the routes. In 512, the method may include removing one or more tasks from a first position of a route and annealing the one or more tasks to a second position of the route to generate a modified route based on execution of the LNS.

In 513, the method may include determining that the modified route is more efficient than the route based on at least one of a travel time difference and a number of overall tasks difference between the route and the modified route, and in response, generating the updated geographic map to include the modified route. In 514, the method may include inserting the one or more tasks at the second position of the route based on execution of at least one of a greedy algorithm and a regret algorithm. In 515, the method may include simultaneously executing a plurality of instances of the LNS on the plurality of subsets of routes using a plurality of different processing cores, respectively, to generate the plurality of modified subsets of routes. In 516, the method may include retrieving attributes of the tasks from a database, wherein the executing further comprises executing the LNS on the attributes to generate the plurality of modified subsets of routes.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer system for optimizing scheduling and dispatching of tasks, the computer system comprising:
a memory; and
at least one processor communicatively coupled to the memory, the at least one processor configured to:
receive a geographic map that comprises tasks assigned to a plurality of vehicles, and routes for the plurality of vehicles to follow to perform the tasks;
cluster the routes into a plurality of subsets of routes based on travel times from geographic locations of the routes in the geographic map, wherein each subset of routes corresponds to a different geographic location;
execute a large neighborhood search (LNS) on the plurality of subsets of routes to generate a plurality of modified subsets of routes for the plurality of vehicles to follow to perform the tasks;
update the geographic map based on the plurality of modified subsets of routes; and
dispatch the tasks to the plurality of vehicles via a communication channel based on the updated geographic map.

2. The computer system of claim 1, wherein the at least one processor is configured to identify geographic centers of the routes based on geographic coordinates of the routes calculated from drive time, and cluster the routes into the plurality of subsets of routes based on the geographic centers of the routes.

3. The computer system of claim 1, wherein the at least one processor is configured to remove one or more tasks from a first position of a route and anneal the one or more tasks to a second position of the route to generate a modified route based on execution of the LNS.

4. The computer system of claim 3, wherein the at least one processor is configured to determine that the modified route is more efficient than the route based on at least one of a travel time difference and a number of overall tasks difference between the route and the modified route, and in response, generate the updated geographic map to include the modified route.

5. The computer system of claim 3, wherein the at least one processor is configured to insert the one or more tasks at the second position of the route based on execution of at least one of a greedy algorithm and a regret algorithm.

6. The computer system of claim 1, wherein the at least one processor is configured to simultaneously execute a plurality of instances of the LNS on the plurality of subsets of routes using a plurality of different processing cores, respectively, to generate the plurality of modified subsets of routes.

7. The computer system of claim 1, wherein the at least one processor is further configured to retrieve attributes of the tasks from a database, and execute the LNS on the attributes to generate the plurality of modified subsets of routes.

8. A computer-implemented method for optimizing scheduling and dispatching of tasks, the computer-implemented method comprising:
receiving a geographic map that comprises tasks assigned to a plurality of vehicles, and routes for the plurality of vehicles to follow to perform the tasks;
clustering the routes into a plurality of subsets of routes based on travel times from geographic locations of the routes in the geographic map, wherein each subset of routes corresponds to a different geographic location;
executing a large neighborhood search (LNS) on the plurality of subsets of routes to generate a plurality of modified subsets of routes for the plurality of vehicles to follow to perform the tasks;
updating the geographic map based on the plurality of modified subsets of routes; and
dispatching the tasks to the plurality of vehicles via a communication channel based on the updated geographic map.

9. The computer-implemented method of claim 8, wherein the clustering comprises identifying geographic centers of the routes based on geographic coordinates of the routes calculated from drive time, and clustering the routes into the plurality of subsets of routes based on the geographic centers of the routes.

10. The computer-implemented method of claim 8, wherein the executing comprises removing one or more tasks from a first position of a route and annealing the one or more tasks to a second position of the route to generate a modified route based on execution of the LNS.

11. The computer-implemented method of claim 10, further comprising determining that the modified route is more efficient than the route based on at least one of a travel time difference and a number of overall tasks difference between the route and the modified route, and in response, generating the updated geographic map to include the modified route.

12. The computer-implemented method of claim 10, wherein the annealing comprises inserting the one or more tasks at the second position of the route based on execution of at least one of a greedy algorithm and a regret algorithm.

13. The computer-implemented method of claim 8, wherein the executing comprises simultaneously executing a plurality of instances of the LNS on the plurality of subsets of routes using a plurality of different processing cores, respectively, to generate the plurality of modified subsets of routes.

14. The computer-implemented method of claim 8, further comprising retrieving attributes of the tasks from a database, wherein the executing further comprises executing the LNS on the attributes to generate the plurality of modified subsets of routes.

15. A computer program product for optimizing scheduling and dispatching of tasks, the computer program product comprising a computer-readable storage medium and program instructions stored on the computer-readable storage medium, wherein the program instructions are executable by a computer processor causing the computer processor to perform one or more functions, the program instructions comprising:
program instructions to receive a geographic map that comprises tasks assigned to a plurality of vehicles, and routes for the plurality of vehicles to follow to perform the tasks;
program instructions to cluster the routes into a plurality of subsets of routes based on travel times from geographic locations of the routes in the geographic map, wherein each subset of routes corresponds to a different geographic location;
program instructions to execute a large neighborhood search (LNS) on the plurality of subsets of routes to generate a plurality of modified subsets of routes for the plurality of vehicles to follow to perform the tasks;
program instructions to update the geographic map based on the plurality of modified subsets of routes; and
program instructions to dispatch the tasks to the plurality of vehicles via a communication channel based on the updated geographic map.

16. The computer program product of claim 15, wherein the clustering comprises identifying geographic centers of the routes based on geographic coordinates of the routes calculated from drive time, and clustering the routes into the plurality of subsets of routes based on the geographic centers of the routes.

17. The computer program product of claim 15, wherein the executing comprises removing one or more tasks from a first position of a route and annealing the one or more tasks to a second position of the route to generate a modified route based on execution of the LNS.

18. The computer program product of claim 17, wherein the program instructions further comprise program instructions to perform determining that the modified route is more efficient than the route based on at least one of a travel time difference and a number of overall tasks difference between the route and the modified route, and in response, generating the updated geographic map to include the modified route.

19. The computer program product of claim 17, wherein the annealing comprises inserting the one or more tasks at the second position of the route based on execution of at least one of a greedy algorithm and a regret algorithm.

20. The computer program product of claim 15, wherein the executing comprises simultaneously executing a plurality of instances of the LNS on the plurality of subsets of routes using a plurality of different processing cores, respectively, to generate the plurality of modified subsets of routes.
